(19) United States
(12) Patent Application Publication
(10) Pub. No.: US 2013/0215356 A1
(43) Pub. Date: Aug. 22, 2013

(54) Connecting Piece for Backlight Module, Backlight Module and LCD Device

(71) Applicant: Yajun Yu, Shenzhen (CN)

(72) Inventor: Yajun Yu, Shenzhen (CN)

(21) Appl. No.: 13/505,495

(22) PCT Filed: Feb. 28, 2012
(86) PCT No.: PCT/CN2012/071697

§ 371 Date: May 2, 2012

(30) Foreign Application Priority Data
Feb. 16, 2012 (CN) 201210034156.2

(51) Int. Cl. G02F 1/13357; F21V 8/00; F21V 21/00

(52) U.S. Cl. 349/58; 362/457; 362/633

(57) ABSTRACT

The invention relates to the field of LCDs, and more particularly to a connecting piece for a backlight module, a backlight module and an LCD device having the connecting piece. The connecting piece of the invention includes a column shaft, both ends of the column shaft are respectively provided with clamping caps; an upper rubber frame, a lower rubber frame or a backplane, a light guide plate, an optical film, and a reflector plate of the backlight module are respectively provided with through holes, and the column shaft of the connecting piece penetrates through the through holes and positions and locks the upper rubber frame, the lower rubber frame or the backplane, the light guide plate, the optical film, and the reflector plate by the clamping caps. The invention breaks through the concept of the fastener matching structure of the backlight module in the prior art, and designs a connecting piece for a backlight module with the functions of positioning and locking; the positioning and locking structure enables the backlight module to be assembled simply, conveniently, and efficiently.

### TECHNICAL FIELD

The invention relates to the field of liquid crystal displays (LCDs), and more particularly to a connecting piece for a backlight module, a backlight module and an LCD device comprising the connecting piece.

### BACKGROUND

A conventional LCD device includes a backlight module. Generally, the locking and fixing of the backlight module employs a fastener matching mode. For example, U.S. Pat. Pub. No. US005729310A applied by the Sharp Corporation discloses a fastener matching structure for a backlight module, in which an upper rubber frame and a lower rubber frame are matched and locked by protrusion(s) and depression(s) therebetween to achieve the purpose that an optical film and a light guide panel between the upper rubber frame and the lower rubber frame are clamped. The matching structure has good locking capacity. However, because edge localization is employed, the positioning of the upper and lower rubber frames, the light guide panel, and the optical film is poor. Thus, a novel structure with functions of both positioning and locking is required.

### SUMMARY

The aim of the invention is to provide a connecting piece for a backlight module with functions of both positioning and locking, a backlight module and an LCD device comprising the connecting piece.

The purpose of the invention is achieved by the following technical scheme.

A connecting piece for a backlight module, comprises: a column shaft; both ends of the column shaft are respectively provided with clamping caps.

Preferably, the column shaft is further provided with a radial protruding clamping structure. The clamping structure divides the column shaft into two sections, and either section can independently lock some components. The locking force can be separately controlled, thus, easy adjustment and preferable locking effects can be obtained.

Preferably, two clamping caps both are integrated with the column shaft. Thus, the structure of the invention is simple and has a low cost.

Preferably, two clamping caps are separated from the column shaft; alternatively, one clamping cap is integrated with the column shaft, and the other clamping cap is separated from the column shaft.

Preferably, the clamping caps are connected with the column shaft by screw threads.

Preferably, the clamping caps are connected with the column shaft by clamping tenons.

Preferably, one end of either clamping cap is provided with a fixing hole, the column shaft is inserted into the fixing hole, and a clamping tenon structure is arranged between the clamping cap and the column shaft; alternatively, one end of the column shaft is provided with a fixing hole, the clamping cap is inserted into the fixing hole, and a clamping tenon structure is arranged between the clamping cap and the column shaft.

Preferably, the front end of the clamping cap is in a guiding type conical structure, which can conveniently penetrate through through holes of all the components.

Preferably, the clamping cap is provided with one or more vertical notches to form multiple clamping hooks. The multiple clamping hooks which are separated can conveniently penetrate through through holes of all the components.

The invention further comprises a backlight module, comprising: an upper rubber frame, a lower rubber frame or a backplane, a light guide plate, an optical film, a reflector plate, and a connecting piece; the connecting piece comprises a column shaft, both ends of the column shaft are respectively provided with clamping caps; the upper rubber frame, the lower rubber frame or the backplane, the light guide panel, the optical film, and the reflector plate are respectively provided with through holes in the corresponding position, and the column shaft of the connecting piece penetrates through the through holes and positions and locks the upper rubber frame, the lower rubber frame or the backplane, the light guide plate, the optical film, and the reflector plate by the clamping caps.

Preferably, the column shaft of the connecting piece is further provided with a radial protruding clamping structure, the connecting piece is fixed on the lower rubber frame or the backplane by the clamping structure and one clamping cap, and the upper rubber frame, the light guide plate, the optical film, and the reflector plate are locked by the clamping structure and the other clamping cap. The clamping structure divides the column shaft into two sections, either section can independently lock some components, the locking force can be separately controlled, and thus, easy adjustment and better locking effects can be obtained.

Preferably, the column shaft of the connecting piece is further provided with a radial protruding clamping structure, the connecting piece is fixed on the upper rubber frame by the clamping structure and one clamping cap, and the lower rubber frame or the backplane, the light guide plate, the optical film, and the reflector plate are locked by the clamping structure and the other clamping cap.

Preferably, the two clamping caps of the connecting piece are integrated with the column shaft.

Preferably, the two clamping caps of the connecting piece are separated from the column shaft; alternatively, one clamping cap is integrated with the column shaft, and the other clamping cap is separated from the column shaft, which facilitates the assembly of the backlight module.

Preferably, the clamping caps of the connecting piece are connected with the column shaft by screw threads.

Preferably, the clamping caps of the connecting piece are connected with the column shaft by clamping tenons.

Preferably, one end of either clamping cap of the connecting piece is provided with a fixing hole, the column shaft is inserted into the fixing hole, and a clamping tenon structure is arranged between the clamping cap and the column shaft; alternatively, one end of the column shaft is provided with a fixing hole, the clamping cap is inserted into the fixing hole, and a clamping tenon structure is arranged between the clamping cap and the column shaft.

Preferably, the front end of the clamping cap of the connecting piece is in a guiding type conical structure.

Preferably, the clamping cap of the connecting piece is provided with one or more vertical notches to form multiple clamping hooks.

The invention further provides an LCD device, comprising: a backlight module; the backlight module comprises an upper rubber frame, a lower rubber frame or a backplane, a light guide plate, an optical film, a reflector plate, and a connecting piece; the connecting piece comprises a column shaft, and both ends of the column shaft are respectively provided with clamping caps; the upper rubber frame, the lower rubber frame or the backplane, the light guide plate, the optical film, and the reflector plate are respectively provided with through holes in the corresponding position, and the column shaft of the connecting piece penetrates through the through holes and then positions and locks the upper rubber frame, the lower rubber frame or the backplane, the light guide plate, the optical film, and the reflector plate by the clamping caps.

Preferably, the column shaft of the connecting piece is further provided with a radial protruding clamping structure, the connecting piece is fixed on the lower rubber frame or the backplane by the clamping structure and one clamping cap, and the upper rubber frame, the light guide plate, the optical film, and the reflector plate are locked by the clamping structure and the other clamping cap.

Preferably, the column shaft of the connecting piece is further provided with a radial protruding clamping structure, the connecting piece is fixed on the upper rubber frame by the clamping structure and one clamping cap, and the lower rubber frame or the backplane, the light guide panel, the optical film, and the reflector plate are locked by the clamping structure and the other clamping cap.

Preferably, the two clamping caps of the connecting piece are separated from the column shaft; alternatively, one clamping cap is integrated with the column shaft, and the other clamping cap is separated from the column shaft.

Preferably, one end of either clamping cap of the connecting piece is provided with a fixing hole, the column shaft is inserted into the fixing hole, and a clamping tenon structure is arranged between the clamping cap and the column shaft; alternatively, one end of the column shaft is provided with a fixing hole, the clamping cap is inserted into the fixing hole, and a clamping tenon structure is arranged between the clamping cap and the column shaft.

Preferably, the front end of the clamping cap of the connecting piece is in a guiding type conical structure.

Advantages of the invention are summarized below: the invention breaks through the concept of the fastener matching structure of the backlight module in the prior art, and designs a connecting piece for a backlight module with the functions of positioning and locking; the column shaft of the connecting piece penetrates through the through holes of the upper rubber frame, the lower rubber frame or the backplane, the light guide plate, the optical film, and the reflector plate, and then accurately positions the aforementioned components; the clamping caps arranged at the upper and lower ends of the column shaft are respectively in contact with the upper and lower rubber frames, and lock the light guide plate, the optical film, and the reflector plate between the upper rubber frame and the lower rubber frame. The positioning locking structure enables the assembly of the backlight module to be more simple, convenient, and efficient.

### BRIEF DESCRIPTION OF FIGURES

FIG. 1 is a sectional view of an assembly structure of a backlight module according to one example of the invention;

FIG. 2 is a sectional view of a connecting piece of a first example of the invention;

FIG. 3 is a sectional view of an assembly structure of a backlight module according to another example of the invention;

FIG. 4 is a sectional view of a connecting piece of a second example of the invention;

FIG. 5 is a sectional view of a connecting piece of a third example of the invention;

FIG. 6 is an enlarged view of A shown in FIG. 5;

FIG. 7 is a sectional view of a connecting piece of a fourth example of the invention;

FIG. 8 is a sectional view of a connecting piece of a fifth example of the invention; and

FIG. 9 is an enlarged view of B shown in FIG. 8.

Wherein: 1. connecting piece; 11. column shaft; 12. clamping cap; 13. clamping structure; 14. clamping tenon structure; 2. upper rubber frame; 3. lower rubber frame; 4. light guide plate; 5. optical film; 6. reflector plate.

### DETAILED DESCRIPTION

The invention discloses a connecting piece for a backlight module. As shown in FIG. 2 shows, a first example of the connecting piece comprises a column shaft 11, both ends of the column shaft 11 are respectively provided with clamping caps 12.

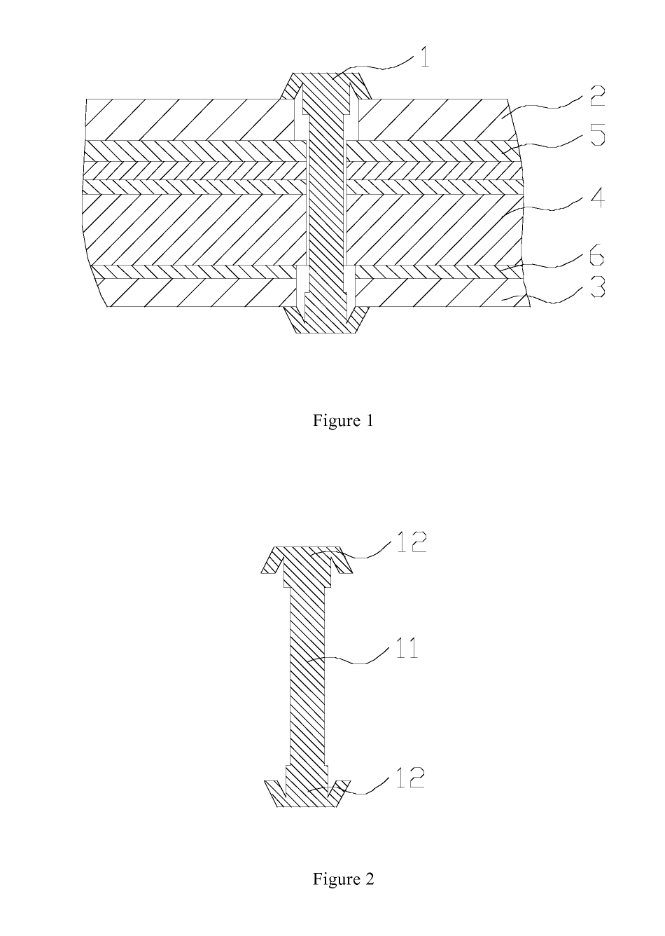

The invention further discloses an LCD device comprising a backlight module. The backlight module employs the above-mentioned connecting piece. A first example of the backlight module is shown in FIG. 1, and the backlight module comprises an upper rubber frame 2, a lower rubber frame 3, a light guide panel 4, an optical film 5, and a reflector plate 6; the upper rubber frame 2, the lower rubber frame 3, the light guide plate 4, the optical film 5, and the reflector plate 6 are respectively provided with through holes in the corresponding position. The column shaft 11 of the connecting piece 1 penetrates through the through holes, and positions and locks the upper rubber frame 2, the lower rubber frame 3, the light guide plate 4, the optical film 5, and the reflector plate 6 by the clamping caps. In the example, the two clamping caps 12 of the connecting piece 1 both are integrated with the column shaft 11. The outer diameter of either clamping cap 12 is more than the diameter of each through hole. The front end of the clamping cap 12 is in a guiding type conical structure with certain elasticity, and conveniently penetrates through the through holes of all the aforementioned components. Optionally, the clamping cap 12 can be provided with one or more vertical notches to form multiple clamping hooks; the clamping hooks can conveniently penetrate through the through holes of all the components.

The invention breaks through the concept of the fastener matching structure of the backlight module in the prior art, and designs a connecting piece 1 for a backlight module with the functions of positioning and locking; the column shaft 11 of the connecting piece 1 penetrates through the through holes of the upper rubber frame 2, the lower rubber frame 3, the light guide plate 4, the optical film 5, and the reflector plate 6, and then accurately positions the aforementioned components; the clamping caps 12 arranged at the upper and lower ends of the column shaft 11 are respectively in contact with the upper and lower rubber frames, and lock the light guide plate 4, the optical film 5, and the reflector plate 6 between the upper rubber frame and the lower rubber frame. The positioning locking structure enables the assembly of the backlight module to be more simple, convenient, and efficient.

The backlight module of the invention can employ one or more aforementioned connecting pieces. Each side of the backlight module is provided with one or more connecting pieces. When some sides do not employ the connecting pieces, conventional mode can be used for locking, such as screws, fasteners and the like.

The lower rubber frame of the invention can be a backplane, and the backplane is made of common metal material.

A second example of the connecting piece for the backlight module of the invention is shown in FIG. 4, and the second example is different from the first example in that: the column shaft 11 is further provided with a radial protruding clamping structure 13, the clamping structure 13 divides the column shaft into two sections, either section can independently lock some components, and the locking force can be separately controlled, thus, easy adjustment and preferable locking effects can be obtained.

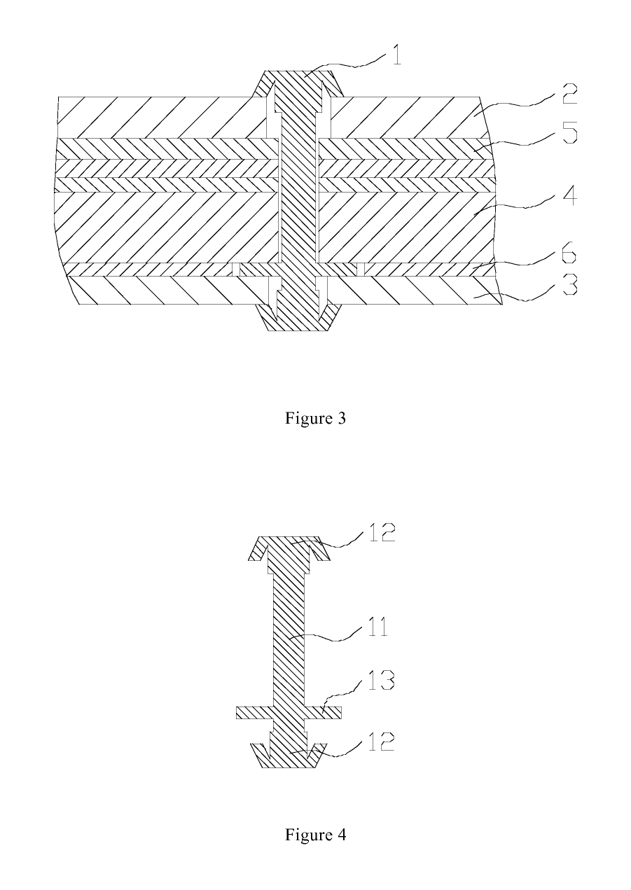

The second example of the backlight module of the invention is shown in FIG. 3. The connecting piece shown in FIG. 4 is used by the backlight module. The connecting piece 1 is fixed on the lower rubber frame 3 through the clamping structure 13 and one clamping cap 12, and the upper rubber frame 2, the light guide plate 4, the optical film 5, and the reflector plate 6 are locked by the clamping structure 13 and the other clamping cap 12. The locking force of the connecting piece 1 of the example can be separately controlled, thus, easy adjustment and preferable locking effects can be obtained, and the backlight module can be conveniently assembled. The upper rubber frame 2, the light guide plate 4, and the optical film 5 are integratedly locked, and then are locked on the lower rubber frame 3; optionally, the connecting piece 1 is locked on the lower rubber frame 3, and then the upper rubber frame 2, the light guide plate 4, and the optical film 5 are locked on the lower rubber frame 3.

In another example, by simple position replacement, the connecting piece 1 is fixed on the upper rubber frame 2 by the clamping structure 13 and one clamping cap 12, and the lower rubber frame 3, the light guide plate 4, the optical film 5, and the reflector plate 6 are locked by the clamping structure 13 and the other clamping cap 12. Because of consistent principle and simple structure, the example will not give unnecessary details.

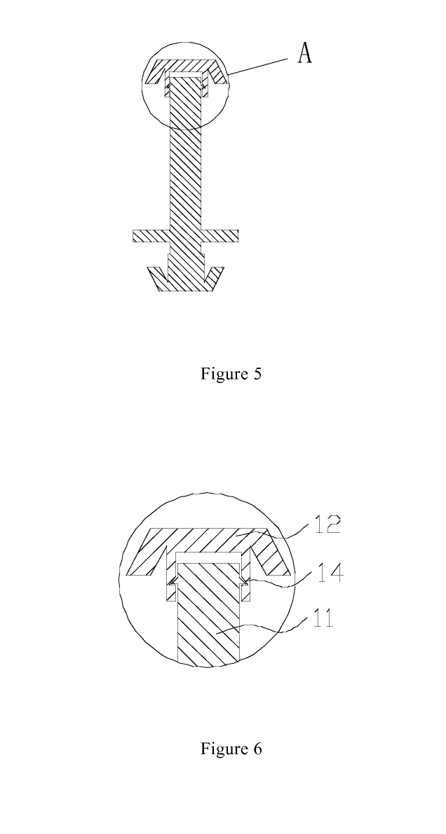

A third example of the connecting piece for the backlight module of the invention is shown in FIG. 5 and FIG. 6. The third example is different from the second example in that: one clamping cap 12 of the connecting piece 1 is integrated with the column shaft 11, and the other clamping cap 12 is separated from the column shaft 11; the clamping cap 12 is connected with the column shaft 11 by screw threads, or the clamping cap 12 is connected with the column shaft 11 by a clamping tenon structure 14. In the example, one end of either clamping cap 12 is provided with a fixing hole, the column shaft 11 is inserted into the fixing hole, and a clamping tenon structure 14 is arranged between the clamping cap 12 and the column shaft 11; specifically, the inner wall of the fixing hole of the clamping cap 12 is provided with clamping groove(s) which is inwardly concave, the surface of the column shaft 11 is provided with protruding clamping hook(s), and the clamping cap 12 is connected with the column shaft 11 when the clamping hook is fastened with the clamping groove.

Thus, the upper rubber frame 2, the light guide panel 4, and the optical film 5 are sheathed on the column shaft 11 of the connecting piece 1, followed by installation of the clamping cap 12, and then all the components are locked. The upper rubber frame 2 and the lower rubber frame 3 are generally made of hard plastic rubber, and the backplane is generally made of a metal piece. When the connecting piece 1 interference penetrates through the through holes thereon, great influence will not be caused in general. Because the optical film is thin and soft generally, when the outer diameter of either clamping cap 12 is not far from the diameter of each through hole, interference penetration will not cause damage to the optical film 5. However, to obtain preferable tightening effects, the outer diameter of the clamping cap 12 is selectively increased in general. At this moment, if interference penetration is still performed, adverse effects may be caused onto the optical film 5. After the clamping caps 12 and the column shaft 11 are separately designed, no interference penetration exists, and the influence of the clamping caps 12 to the optical film 5 needs not to be worried.

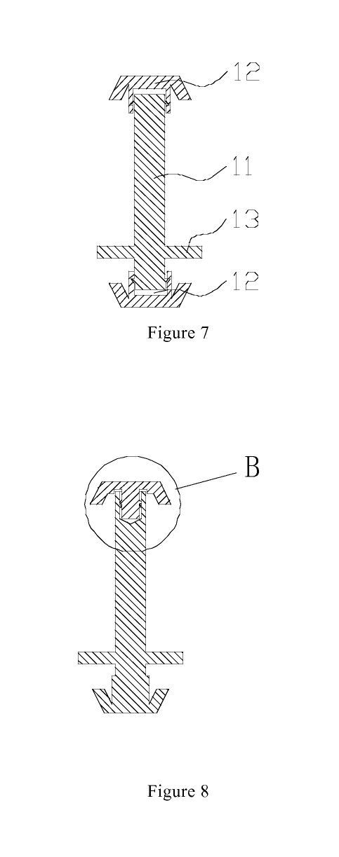

A fourth example of the connecting piece for the backlight module of the invention is shown in FIG. 7. The two clamping caps 12 of the connecting piece 1 are separated from the column shaft 11, and are connected with the column shaft 11 by a clamping tenon structure 14. The beneficial effect of the separate structure is consistent with that described in example 3, the example will not give unnecessary details.

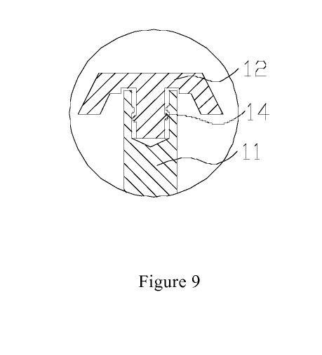

A fifth example of the connecting piece for the backlight module of the invention is shown in FIG. 8 and FIG. 9. One clamping cap 12 of the connecting piece is integrated with the column shaft 11, and the other clamping cap 12 is separated from the column shaft 11. One end of the column shaft 11 is provided with a fixing hole, the clamping cap 12 is inserted into the fixing hole, and a clamping tenon structure 14 is arranged between the clamping cap 12 and the column shaft 11. Specifically, the clamping tenon structure 14 is a protruding clamping hook arranged on the outside surface of the clamping cap 12. The inner wall of the fixing hole of the column shaft 11 is provided with protruding clamping hooks, and the clamping cap 12 is connected with the column shaft 11 when the clamping hook is fastened with the clamping hook.

All the aforementioned connecting pieces of the invention can be applied to the backlight module and the LCD device of the invention, and can perform the beneficial effects of simple, convenient, and efficient assembly.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. A connecting piece for a backlight module, comprising: a column shaft; both ends of said column shaft being respectively provided with clamping caps.

2. The connecting piece for the backlight module of claim 1, wherein said column shaft is further provided with a radial protruding clamping structure.

3. The connecting piece for the backlight module of claim 1, wherein two clamping caps both are separated from said column shaft; alternatively, one clamping cap is integrated with said column shaft, and the other clamping cap is separated from said column shaft.

4. The connecting piece for the backlight module of claim 3, wherein said clamping caps are connected with said column shaft by screw threads.

5. The connecting piece for backlight module of claim 3, wherein said clamping caps are connected with said column shaft by clamping tenons.

6. The connecting piece for the backlight module of claim 5, wherein one end of either said clamping cap is provided with a fixing hole, said column shaft is inserted into said fixing hole, and a clamping tenon structure is arranged between said clamping cap and said column shaft; alternatively, one end of said column shaft is provided with a fixing hole, said clamping cap is inserted into said fixing hole, and a clamping tenon structure is arranged between said clamping cap and said column shaft.

7. The connecting piece for the backlight module of claim 1, wherein the front end of either said clamping cap is in a guiding type conical structure.

8. The connecting piece for the backlight module of claim 7, wherein either said clamping cap is provided with one or more vertical notches to form multiple clamping hooks.

9. A backlight module, comprising: an upper rubber frame, a lower rubber frame or a backplane, a light guide plate, an optical film(s), a reflector plate, and a connecting piece; wherein said connecting piece comprises a column shaft, and both ends of said column shaft are respectively provided with clamping caps; said upper rubber frame, said lower rubber frame or said backplane, said light guide plate, said optical diaphragm, and said reflector plate are respectively provided with through holes in the corresponding position; the column shaft of said connecting piece penetrates into said through holes and positions and locks said upper rubber frame, said lower rubber frame or said backplane, said light guide plate, said optical film, and said reflector plate by the clamping caps.

10. The backlight module of claim 9, wherein the column shaft of said connecting piece is further provided with a radial protruding clamping structure; said connecting piece is fixed on the lower rubber frame or the backplane by the clamping structure and one clamping cap, and the upper rubber frame, the light guide plate, the optical film, and the reflector plate are locked by the clamping structure and the other clamping cap.

11. The backlight module of claim 9, wherein the column shaft of said connecting piece is further provided with a radial protruding clamping structure; said connecting piece is fixed on the upper rubber frame by the clamping structure and one clamping cap, and the lower rubber frame or the backplane, the light guide plate, the optical film, and the reflector plate are locked by the clamping structure and the other clamping cap.

12. The backlight module of claim 9, wherein the two clamping caps of said connecting piece are separated from said column shaft; alternatively, one clamping cap is integrated with said column shaft, and the other clamping cap is separated from said column shaft.

13. The backlight module of claim 12, wherein one end of either clamping cap of said connecting piece is provided with a fixing hole, said column shaft is inserted into said fixing hole, and a clamping tenon structure is arranged between said clamping cap and said column shaft; alternatively, one end of said column shaft is provided with a fixing hole, said clamping cap is inserted into said fixing hole, and a clamping tenon structure is arranged between said clamping cap and said column shaft.

14. The backlight module of claim 9, wherein the front end of either clamping cap of said connecting piece is in a guiding type conical structure.

15. An LCD device, comprising: a backlight module; wherein said backlight module comprises an upper rubber frame, a lower rubber frame or a backplane, a light guide plate, an optical film, a reflector plate, and a connecting piece; said connecting piece comprises a column shaft, both ends of said column shaft are respectively provided with clamping caps; said upper rubber frame, said lower rubber frame or said backplane, said light guide plate, said optical film, and said reflector plate are respectively provided with through holes in the corresponding position; the column shaft of said connecting piece penetrates through said through holes and positions and locks said upper rubber frame, said lower rubber frame or said backplane, said light guide plate, said optical film, and said reflector plate by said clamping caps.

16. The LCD device of claim 15, wherein the column shaft of said connecting piece is further provided with a radial protruding clamping structure, said connecting piece is fixed on the lower rubber frame or the backplane by the clamping structure and one clamping cap, and the upper rubber frame, the light guide panel, the optical film, and the reflector plate are locked by the clamping structure and the other clamping cap.

17. The LCD device of claim 15, wherein the column shaft of said connecting piece is further provided with a radial protruding clamping structure, said connecting piece is fixed on the upper rubber frame by the clamping structure and one clamping cap, and the lower rubber frame or the backplane, the light guide plate, the optical film, and the reflector plate are locked by the clamping structure and the other clamping cap.

18. The LCD device of claim 15, wherein the two clamping caps of said connecting piece are separated from said column shaft; alternatively, one clamping cap is integrated with said column shaft, and the other clamping cap is separated from said column shaft.

19. The LCD device of claim 18, wherein one end of either clamping cap of said connecting piece is provided with a fixing hole, said column shaft is inserted into said fixing hole, and a clamping tenon structure is arranged between said clamping cap and said column shaft; alternatively, one end of said column shaft is provided with a fixing hole, said clamping cap is inserted into said fixing hole, and a clamping tenon structure is arranged between said clamping cap and said column shaft.

20. The LCD device of claim 15, wherein the front end of either clamping cap of said connecting piece is in a guiding type conical structure.
